(19) United States
(12) Patent Application Publication
(10) Pub. No.: US 2014/0002898 A1
(43) Pub. Date: Jan. 2, 2014

(54) Display Apparatus and Display Method Using Invisible Light

(71) Applicant: Tae Jung Kim, Seoul (KR)

(72) Inventor: Tae Jung Kim, Seoul (KR)

(21) Appl. No.: 13/979,227

(22) PCT Filed: Jan. 9, 2012
(86) PCT No.: PCT/KR12/00202

§ 371 Date: Sep. 18, 2013

(30) Foreign Application Priority Data
Jan. 13, 2011 (KR) 10-2011-0003693

(51) Int. Cl. G02B 27/22

(52) U.S. Cl. CPC G02B 27/22
USPC 359/464; 250/503.1; 250/493.1

(57) ABSTRACT

The present invention relates to a display apparatus and to a display method adopting a novel system capable of displaying images using light in the invisible spectrum instead of using light in the visible spectrum which can be observed by the naked eye of a human. The novel system may be applied to various display apparatuses such as a television, a computer monitor, a mobile phone, a game console screen, and an outdoor advertisement display panel for displaying a variety of pieces of information such as documents, pictures, and videos.

### TECHNICAL FIELD

The present invention relates to a display apparatus and method, and, more particularly, to a novel-type display apparatus and method that display information using light in the invisible spectrum, rather than displaying information using light in the visible spectrum that can be observed by a human's naked eye, as in existing display apparatuses, for the purposes of application to display apparatuses for displaying a variety of types of information, such as text, pictures, and moving images, for example, a TV, a computer monitor, a mobile phone, the screen of a game console, and an outdoor advertizing display panel.

### BACKGROUND ART

With the development of electronic engineering, various types of display apparatuses have been developed. Display apparatuses that have been developed so far, such as a TV, a computer monitor, a mobile phone, the screen of a game console, and an outdoor advertizing display panel, may be classified into a CRT (Cathode Ray Tube) type, an LCD (Liquid Crystal Display) type, an LED (Light Emitting Diode) type and a PDP (Plasma Display Panel) type. All the display apparatuses that have been developed so far perform display using visible light that can be perceived by a human using the naked eye, that is, electromagnetic waves having wavelengths in the range of about 400 nm to 700 nm.

That is, a CRT-type display method uses the principle of emitting an electron beam from an electronic gun using an electrical signal and exciting a fluorescent material using the emitted electron beam, thereby generating light, in which case R (reddish), G (greenish) and B (bluish) light can be generated from fluorescent materials by controlling the types of fluorescent materials. An LCD-type display method uses the principle of locating a backlight on one side of liquid crystals and passing or blocking the light of the backlight by changing the arrangement of the liquid crystals using electrical signals, thereby emitting light, in which case R, G, and B light is generated by passing the light of the backlight or passing the light of the backlight through a color filter. An LED-type display method uses the characteristic of a light emitting diode in which electrons in a high energy state emit light while transitioning to a low energy state, in which case the R, G and B primary colors can be generated by adjusting the amounts of energy. A PDP-type display method uses light that is emitted from a plasma that is formed in the case of gas, in which case monochromatic display is performed directly using light in the visible spectrum when the light in the visible spectrum is generated depending on the type of gas, or color display is performed by exciting RGB color generating fluorescent substances using light that is generated from a plasma.

The above-described conventional display methods are methods that display information using a single ray of light or a plurality of rays of light in a specific wavelength range that belongs to the spectrum of visible light that can be observed by a human's naked eye.

However, the conventional display apparatuses using visible light is problematic in that the observation of information being played via the display apparatuses cannot be limited to specific users because all humans can observe the information and thus persons other than specific users who are using the display apparatuses can observe the information. Furthermore, they are problematic in that it is impossible to display information at night or in a dark space without brightening a display screen and a region around the display screen because visible light is used to transfer information and thus the display screen is brightened as well.

### DISCLOSURE

### Technical Problem

Accordingly, the present invention has been made keeping in mind the above problems occurring in the prior art, and an object of the present invention is to provide a display apparatus and method using invisible light that enables information to be observed only by a specific user without being observed by many unspecified persons and can also display information without brightening a display screen and an area around the screen to expose them to the outside at night or in a dark space.

Another object of the present invention is to provide a display apparatus and method that add invisible light to an existing method of displaying information using visible light and then enable many unspecified users to observe information using an existing RGB method and a specific user to observe information including information in the invisible light spectrum.

### Technical Solution

First, the characteristics of the present invention are summarized. In order to accomplish the above objects, an aspect of the present invention provides a display method, wherein the display method generates light in the invisible spectrum and displays an image, formed by the light in the invisible spectrum, on a screen.

The display method may enable the displayed image to be watched using means for enabling a user to view the light in the invisible spectrum.

The light in the invisible spectrum may be light in the infrared or ultraviolet spectrum.

The screen may be configured such that pixels arranged in a 2D array each include infrared or ultraviolet light generation means, and the image may be generated by controlling the infrared or ultraviolet light generation means and thereby adjusting an amount of generation of infrared or ultraviolet light of each of the pixels (direct type).

The display method may place a light source configured to generate both light in a visible spectrum and the light in the invisible spectrum behind the screen, block the light in the visible spectrum using an optical filter, and transmit only the light in the invisible spectrum; and may radiate the transmitted light in the invisible spectrum on the screen in which pixels arranged in a 2D array each include switching means for transmitting or blocking light, and forms the image by controlling the switching means and thereby the amount of transmission of the light in the invisible spectrum in each of the pixels (filter type).

The screen may be configured such that pixels arranged in a 2D array each include a fluorescent material; and the display method may radiate an electron beam or light onto the fluorescent material of each of the pixels by adjusting energy generated behind the screen, and form the image by adjusting the amount of generation of the light in the invisible spectrum in the pixel (fluorescent type).

The display method may further generate light in a visible spectrum, and further display an image, formed by the light in the visible spectrum, on a screen; and may enable the images formed by the light in the visible spectrum and the light in the invisible spectrum to be watched.

The image displayed on the screen may be a 3D image that is formed of a combination of a left-eye image formed by the light in the visible spectrum and a right-eye image formed by the light in the invisible spectrum; and a user who wears a spectacle-type watching assistance means may watch the left-eye image using a left-eye filter of the assistance means and watch the right-eye image using a right-eye filter of the assistance means.

The image formed by the light in the visible spectrum and the image formed by the light in the invisible spectrum may be implemented on a physically single panel or film; or physically different panels or films.

Another aspect of the present invention provides a display apparatus, including a light source configured to generate light in the invisible spectrum; and a screen configured to display an image formed by the light in the invisible spectrum.

The display apparatus may enable the displayed image to be watched using means for enabling a user to view the light in the invisible spectrum.

### Advantageous Effects

The display apparatus and method according to the present invention reproduce information using invisible light, thereby enabling information to be observed only by a specific user without being observed by many unspecified persons, and also displaying information without brightening a display screen and an area around the screen to expose them to the outside at night or in a dark space.

The present invention adds invisible light to an existing method of displaying information using visible light and then enables many unspecified users to observe information using an existing visible method and a specific user to observe information including information in the invisible light spectrum. When a 3D image is watched based on the principle of the present invention, a 2D image can be watched using the naked eye and a 3D image can be watched when specialized observation equipment is worn, thereby enabling multiple users to observe an image in a 2D or 3D form.

### DESCRIPTION OF DRAWINGS

FIG. 1 is a drawing illustrating infrared light that is generated by the infrared LED of a TV remote control;

FIG. 2 illustrates observational photos of infrared light emitted from the remote control of FIG. 1 in a dark place in a case in which a watching assistance device has been used and in a case in which a watching assistance device has not been used;

FIG. 3 is a diagram illustrating a display apparatus according to an embodiment of the present invention;

FIG. 4 is a diagram illustrating a display apparatus according to another embodiment of the present invention;

FIG. 5 is a diagram illustrating a display apparatus according to still another embodiment of the present invention;

FIG. 6 illustrates an example of use of the invisible light display according to the present invention; and

FIG. 7 illustrates an example in which a 3D display is implemented using both an invisible light display and a visible light display according to the present invention.

### MODE FOR INVENTION

While preferred embodiments of the present invention will be described in detail below with reference to the accompanying drawings and the descriptions of the accompanying drawings, the present invention is not limited or restricted by these embodiments.

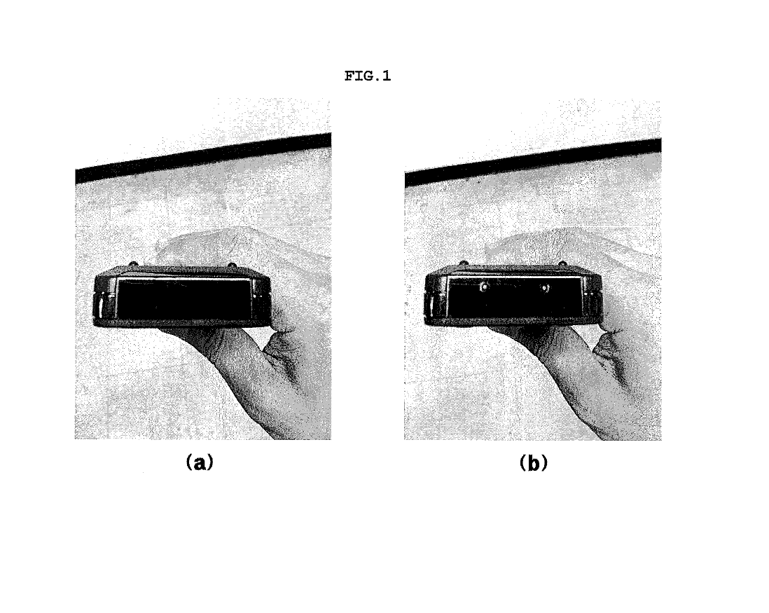

FIG. 1 is a drawing illustrating infrared light that is generated by the infrared LED of a TV remote control. As illustrated in FIG. 1, an infrared LED is mounted in a TV remote control that is widely used in general homes, and the infrared LED outputs light in the infrared light and invisible spectrum when a button on the remote control is pressed. As shown in the left photo of FIG. 1, infrared light emitted from the infrared LED cannot be observed when it is observed using the naked eye. As shown in the right photo of FIG. 1, infrared light emitted from the infrared LED can be observed when it is observed using an assistance device (hereinafter referred to as the “watching assistance device”), such as an infrared light observation device or the liquid crystal of a CCD (Charge Coupled Device) digital camera that detects infrared light.

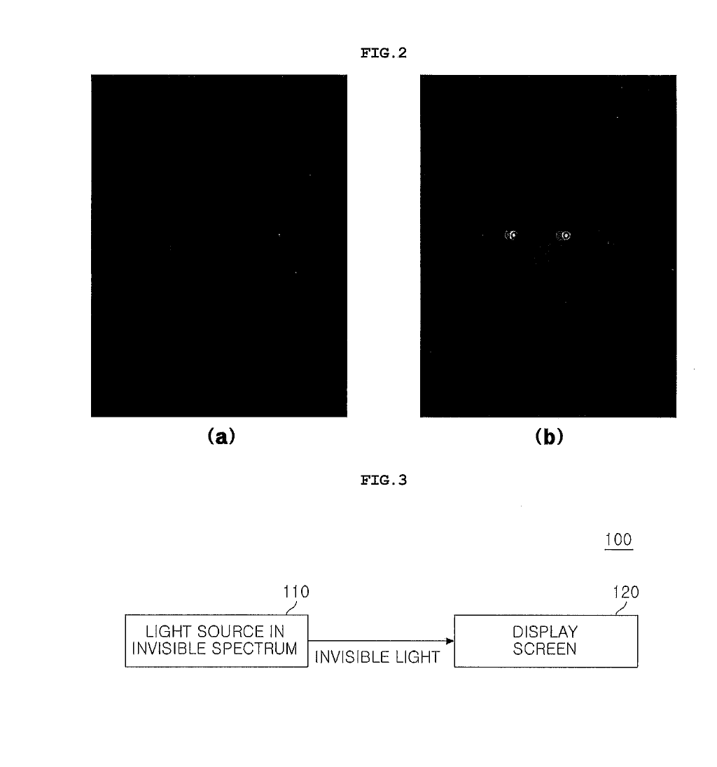

FIG. 2 shows photos of a case in which infrared light emitted from the remote control of FIG. 1 is observed without using a watching assistance device in a dark space and a case in which the infrared light is observed using a watching assistance device in a dark space. When infrared light emitted from the infrared LED of the TV remote control is observed, as shown in FIG. 2, the infrared light cannot be observed and a display screen and an area around the display screen are not brightened, as shown in the left photo of FIG. 2, and the infrared light can be observed only when it is observed using an watching assistance device, such as an infrared light observation device or the liquid crystal of a CCD digital camera that detects infrared light, as shown in the right photo of FIG. 2.

Although the example using infrared light in the invisible spectrum has been described, the case of using ultraviolet light in the invisible spectrum is the same. That is, ultraviolet light can be observed only when it is observed using a watching assistance device, such as an ultraviolet light observation device.

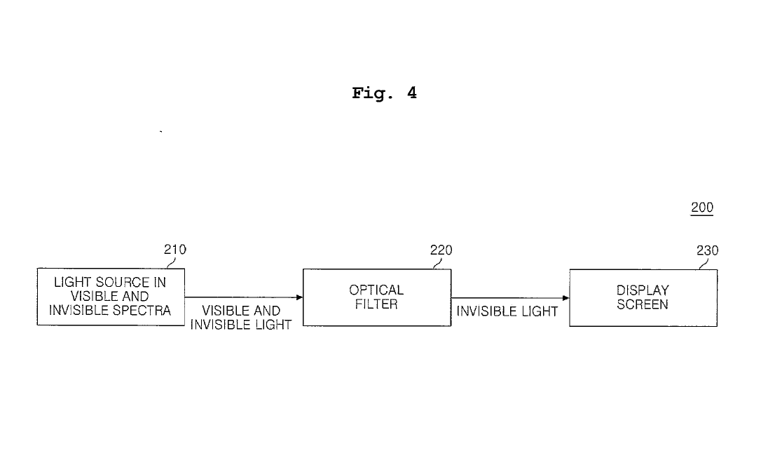

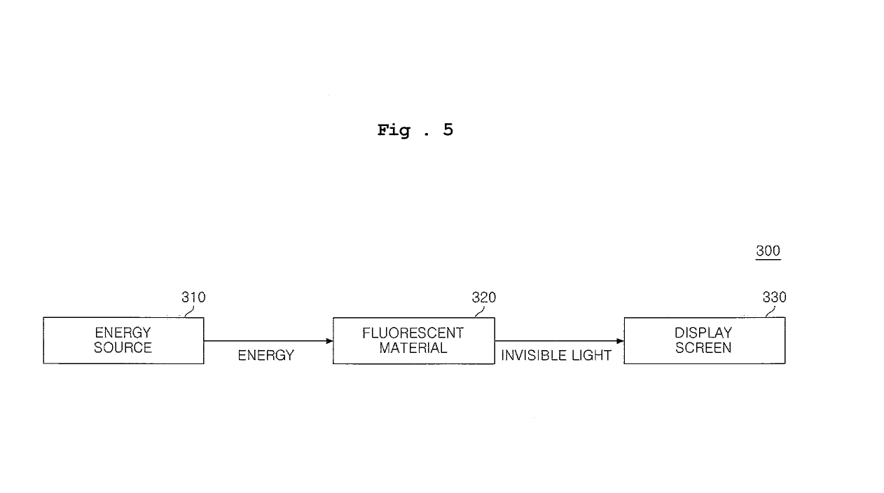

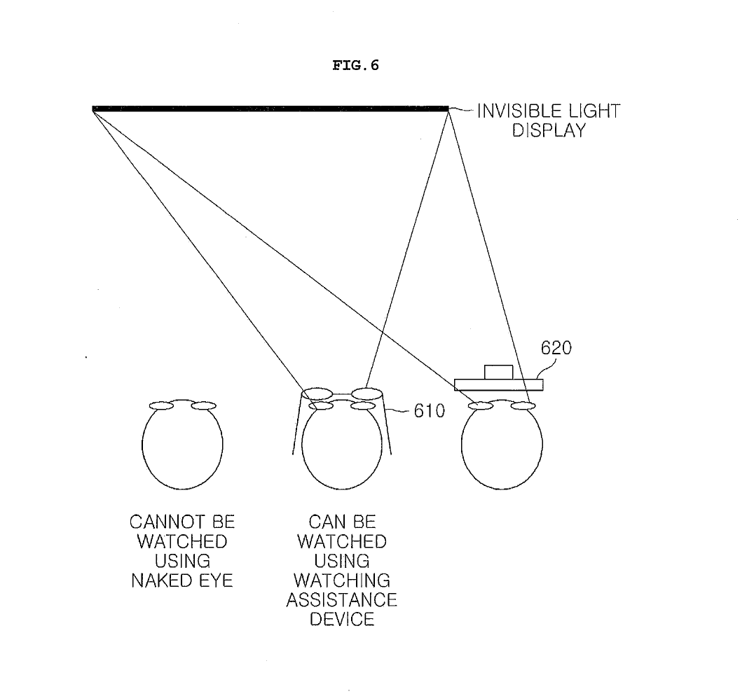

Based on this principle, methods of implementing direct-type (FIG. 3), filter-type (FIG. 4), and fluorescent-type (FIG. 5) display apparatuses according to the present invention will be described below. For example, in the display method according to the present invention, light in the invisible spectrum is generated, and then an image formed by the light in the invisible spectrum (for example, light in the infrared or ultraviolet spectrum) is displayed on a screen. In this case, the image displayed on the screen can be watched using a spectacle-type watching assistance device (see 610 of FIG. 6) or a camera liquid crystal-type watching assistance device (see 620 of FIG. 6) that enables a user to view the light in the invisible spectrum. Accordingly, an image is displayed using invisible light, thereby enabling information to be observed only by a specific user without being observed by many unspecified persons, and also displaying information without brightening a display screen and an area around the screen to expose them to the outside at night or in a dark space.

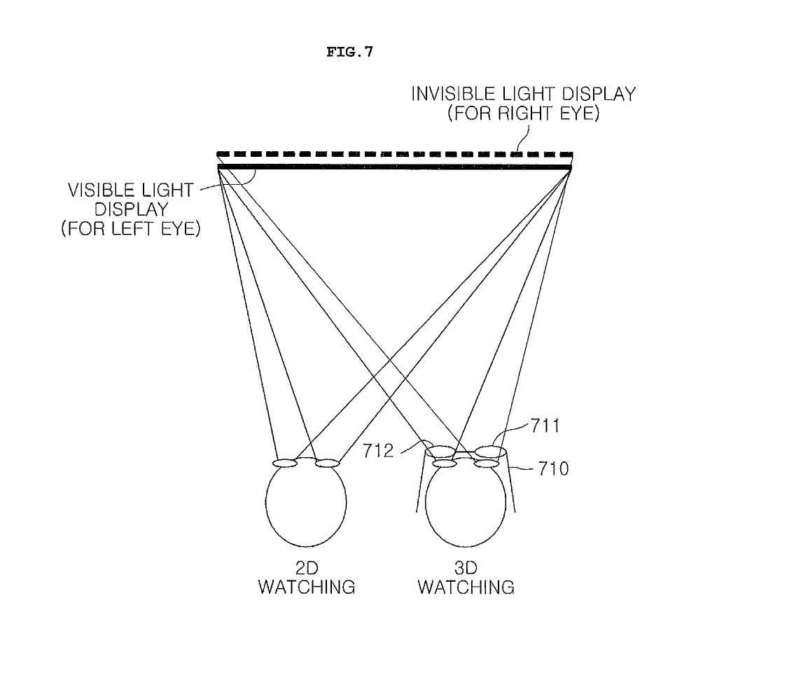

Furthermore, as illustrated in FIG. 7, invisible light is added to a conventional method of displaying information using visible light, thereby enabling many unspecified users to perform observation using the conventional visible light method and also enabling a specific user to observe information including invisible light. Accordingly, a 2D image is watched using the naked eye, and a 3D image can be observed when a spectacle-type watching assistance device is worn, thereby enabling multiple users to simultaneously observe the same image in a 2D or 3D form via the same display apparatus.

FIG. 3 is a diagram illustrating a display apparatus 100 according to an embodiment of the present invention.

Referring to FIG. 3, display apparatus 100 according to an embodiment of the present invention includes a light source 110 and a screen 120. The light source 110 generates light in the invisible spectrum (for example, infrared light or light in the ultraviolet spectrum), and the screen 120 displays an image formed by the light in the invisible spectrum emitted from the light source 110. The user may watch an image displayed on the screen 120 using a spectacle-type watching assistance device (see 610 of FIG. 6) or a CCD digital camera liquid crystal-type watching assistance device (see 620 of FIG. 6) that enables a user to view light in the invisible spectrum.

The screen 120 includes individual pixels arranged in a 2D array. The pixels may include respective infrared or ultraviolet light generation means (for example, infrared/ultraviolet light LEDs, or gaseous plasma) that form the light source 110. An image may be formed on the screen 120 by controlling the infrared or ultraviolet light generation means using an external control device (for example, a control processor) and thereby adjusting the amount of generation of infrared or ultraviolet light of each of the pixels.

The direct-type display apparatus that allows the light source 110 included in each pixel of the screen 120 to directly generate light in the invisible spectrum and then displays the image may be driven using driving methods similar to those of an LED (Light Emitted Diode) and a PDP (Plasma Display Panel). For example, when the infrared/ultraviolet light LED is formed for each pixel and the LED is controlled by an external control device (for example, a control processor), electrons excited to a high energy state emit infrared/ultraviolet light while transitioning to a low energy state. In this case, an image in which luminance is specified for each pixel may be formed on the screen 120 by adjusting the amount of generation of infrared or ultraviolet light of each pixel in response to the voltage control of the control device with respect to the LED. Alternatively, like in a PDP scheme, each pixel of the screen 120 is formed (for example, of a scan electrode, a sustain electrode, an address electrode, etc.), and infrared/ultraviolet light is generated via a gas, such as Kr or Xe, filled into each pixel. In this case, an image in which luminance is specified for each pixel may be formed on the screen 120 by adjusting the amount of generation of infrared or ultraviolet light of each pixel in response to the voltage control of the control device with respect to the electrodes that constitute each pixel.

FIG. 4 is a diagram illustrating a display apparatus 200 according to another embodiment of the present invention.

Referring to FIG. 4, the display apparatus 200 according to the other embodiment of the present invention includes a light source 210, an optical filter 220, and a screen 230. The light source 210 generates both light in the invisible spectrum (for example, light in the infrared or ultraviolet spectrum) and light in the visible spectrum (for example, light in the wavelength range of 400 nm to 700 nm), and the optical filter 220 blocks the light in the visible spectrum emitted from the light source 210 and transmits only the light in the invisible spectrum therethrough. Accordingly, the screen 230 displays an image that is formed by the light in the invisible spectrum. The user may watch the image displayed on the screen 120 using the spectacle-type watching assistance device (see 610 of FIG. 6) or the CCD digital camera liquid crystal-type watching assistance device (see 620 of FIG. 6) that enables the user to view light in the invisible spectrum.

The screen 230 may include individual pixels arranged in a 2D array, in which case each of the pixels may include switching means (for example, a liquid crystal or a thin-film transistor) for transmitting or blocking light. In this case, an image may be formed on the screen 120 by controlling the switching means using an external control device (for example, a control processor) and thereby adjusting the amount of transmission of light in the invisible spectrum emitted from the optical filter 220 and radiated onto each pixel.

The filter-type display apparatus for displaying an image by adjusting the amount of transmission of light in the invisible spectrum passed through the optical filter 220 using the switching means of the screen 230, as described above, may be driven using a driving method similar to that of an LCD (Liquid Crystal Display). For example, a backlight 210 is located on one side of a liquid crystal, light in the visible spectrum is blocked by the optical filter 220, and light in the invisible spectrum is transmitted or blocked by controlling the TFT (Thin Film Transistor) of each pixel using an external control device (for example, a control processor). In this case, an image in which luminance is specified for each pixel may be formed on the screen 230 by adjusting the amount of generation of infrared or ultraviolet light of each pixel in response to the voltage control of the control device with respect to each pixel.

FIG. 5 is a diagram illustrating a display apparatus 300 according to still another embodiment of the present invention.

Referring to FIG. 5, the display apparatus 300 according to still another embodiment of the present invention includes an energy source 310, a fluorescent material 320, and a screen 330.

The energy source 310 generates an electron beam or plasma light, the fluorescent material 320 generates light in the invisible spectrum (for example, light in the infrared or ultraviolet spectrum) depending on an electron beam or plasma light radiated by the energy source 310 and, accordingly, the screen 230 displays an image that is formed by the light in the invisible spectrum. The user may watch the image displayed on the screen 120 using the spectacle-type watching assistance device (see 610 of FIG. 6) or the CCD digital camera liquid crystal-type watching assistance device (see 620 of FIG. 6) that enables the user to view light in the invisible spectrum. The fluorescent material 320 may include benzene (chemical formula: C₆H₆) that emits light in the wavelength range of 270 to 310 nm, toluene (chemical formula: C₆H₆CH₃) that emits light in the wavelength range of 270 to 320 nm, or the like.

For example, the screen 230 includes individual pixels arranged in a 2D array, in which case each of the pixels may include the fluorescent material 320. The amount of energy of an electron beam or plasma light radiated onto the fluorescent material 320 of each pixel may be adjusted using an external control device (for example, a control processor), and therefore the amount of generation of light in the invisible spectrum in each pixel is adjusted, thereby forming an image on the screen 120.

The fluorescence-type display apparatus for displaying an image by causing the fluorescent material 320 of each pixel screen 330 to generate light in the invisible spectrum using an electron beam or plasma light emitted from the energy source 310, may operate in a manner similar to that of a CRT (Cathode Ray Tube) or a PDP (Plasma Display Panel). For example, light in the invisible spectrum may be generated by emitting the electron beam from an electronic gun, that is, the energy source 310, and thereby exciting the fluorescent material 320 of each pixel of the screen 330 using an emitted electron beam, and an image in which luminance is specified for each pixel may be formed on the screen 230 by controlling the electronic gun using an external control device (for example, a control processor) and thereby adjusting the amount of generation of light in the invisible spectrum in the fluorescent material 320. Alternatively, like in a PDP scheme, each pixel of the screen 120 is formed (for example, of a scan electrode, a sustain electrode, an address electrode, etc.), and infrared/ultraviolet light is generated via the fluorescent material 320 formed in each pixel. In this case, an image in which luminance is specified for each pixel may be formed on the screen 330 by adjusting the amount of generation of infrared or ultraviolet light of each pixel in response to the voltage control of the control device with respect to the electrodes that constitute each pixel.

As illustrated in FIGS. 3, 4, and 5, the direct-type (FIG. 3), filter-type (FIG. 4), and fluorescent-type (FIG. 5) display apparatuses 100, 200 and 300 that generate light in the invisible spectrum display an image formed by light in the invisible spectrum (for example, light in the infrared or ultraviolet spectrum) on their screens, and enable a user to watch the image displayed on the screen using the spectacle-type watching assistance device (see 610 of FIG. 6) or the CCD digital camera liquid crystal-type watching assistance device (see 620 of FIG. 6) that enables the user to view light in the invisible spectrum may be driven using a CRT (Cathode Ray Tube) driving method, an LCD (Liquid Crystal Display) driving method, an LED (Lighting Emitting Diode) driving method, or a PDP (Plasma Display Panel) driving method, as exemplified above. The screens 120, 230 and 330 may be fabricated in the form of a rigid panel, such as glass, or in the form of a transparent material film, such as resin, as illustrated in FIG. 6.

When images such as text, pictures, and/or moving images are displayed on the screens 120, 230 and 330 in the form of a panel or a film, as illustrated in FIG. 6, a general user cannot watch the images on the screens 120, 230 and 330, but only a user who wears the spectacle-type watching assistance device 610 or CCD digital camera liquid crystal-type watching assistance device 620 that enables the user to view light in the invisible spectrum can watch the images displayed on the screens 120, 230 and 330. The spectacle-type watching assistance device 610 is means for enabling a user to view light in the invisible spectrum from the screens 120, 230 and 330, and detects transmitted light in the invisible spectrum (infrared or ultraviolet light), converts the transmitted light into visible light, and outputs the visible light onto the surfaces of the right and left lenses of glasses, thereby aiding in watching the corresponding image using the naked eye. Furthermore, the CCD digital camera liquid crystal-type watching assistance device 620 detects transmitted light in the invisible spectrum (infrared or ultraviolet light), converts the transmitted light into visible light, and outputs the visible light onto a liquid crystal screen, thereby aiding in watching the corresponding image using the naked eye.

FIG. 7 illustrates an example in which a 3D display is implemented using both an invisible light display and a visible light display according to the present invention.

As illustrated in FIG. 7, for example, a first image (a 3D right-eye image) formed by light in the invisible spectrum is displayed on the screens 120, 230 and 330, and a second image 3D (a left-eye image) formed by light in the visible spectrum may be further displayed on the single same screen 120, 230 or 330 or a screen that is physically separate and is in the form of a panel or a film. In this case, although a light source is further required for the second image (the 3D left-eye image), the same light source may be used in the case of the light source 210 that generates both light in the invisible spectrum and light in the visible spectrum, as illustrated in FIG. 4.

Even in the case in which a first 3D image and a second 3D image are displayed in different panels or films that are physically distinguished from each other, two screens may be overlaid on each other. When a screen that displays first and second images is implemented using a single panel or film, pixels are divided so that some pixels display an image using light in the invisible spectrum and the other pixels display an image using light in the visible spectrum, periodically. This case may be implemented using a CRT (Cathode Ray Tube) driving method, an LCD (Liquid Crystal Display) driving method, an LED (Light Emitting Diode) driving method, or a PDP (Plasma Display Panel) driving method so that some pixels display an image using light in the invisible spectrum and the other pixels display an image using light in the visible spectrum.

When an image formed by light in the visible spectrum and an image formed by light in the invisible spectrum are displayed on a single screen or on two screens that are overlaid on each other as described above, a first user who watches the display apparatus can observe only an image displayed by visible light, that is, a second image (a 3D left-eye image), and a second user who wears the spectacle-type watching assistance device 710 can observe all images that are transferred in the form of visible light and invisible light.

In this case, with regard to a 3D image, when a 3D image formed of a combination of a left-eye image formed by light in the visible spectrum and a right-eye image formed by light in the invisible spectrum is displayed on a single screen or different screens, a first user who watches the display apparatus using the naked eye can watch only an image displayed by visible light, that is, a second image (a 3D left-eye image), and thus only a 2D image, and a second user who wears the spectacle-type watching assistance device 710 can observe all images that are transferred in the form of visible light and invisible light, thus watching the corresponding image in a 3D manner.

The spectacle-type watching assistance device 710 may include a right-eye filter 711 configured to watch a first image (a 3D right-eye image) and located on a right lens portion, and a left-eye filter 712 configured to watch a second image (a 3D left-eye image) and located on a left lens portion. In this case, the left-eye filter 712 blocks light in the invisible spectrum and transmits light in the visible spectrum, while the right-eye filter 711 blocks light in the visible spectrum and transmits light in the invisible spectrum.

In accordance with this principle, the present invention adds invisible light to a conventional method of displaying information using visible light, thereby enabling many unspecified users to perform observation using the conventional visible light method and also enabling a specific user to observe information including invisible light. Furthermore, in accordance with this principle, the present invention enables many unspecified users to observe an image in a 2D form and enables a specific user to observe the same image in a 3D form, thereby enabling multiple users to simultaneously observe the same image in a 2D or 3D form via the same display apparatus.

Although the present invention has been described in conjunction with the limited embodiments and drawings, the present invention is not limited to the embodiments, but those having ordinary knowledge in the technical field to which the present invention pertains can make various modifications and variation based on the above description. Therefore, the scope of the present invention should not be limited to the described embodiments, but should be determined based on not only the attached claims but also the equivalents thereof.

1. A display method, wherein the display method generates light in an invisible spectrum and displays an image, formed by the light in the invisible spectrum, on a screen.

2. The display method of claim 1, wherein the display method enables the displayed image to be watched using means for enabling a user to view the light in the invisible spectrum.

3. The display method of claim 1, wherein the light in the invisible spectrum is light in an infrared or ultraviolet spectrum.

4. The display method of claim 1, wherein:
the screen is configured such that pixels arranged in a 2D array each include infrared or ultraviolet light generation means, and the image is generated by controlling the infrared or ultraviolet light generation means and thereby adjusting an amount of generation of infrared or ultraviolet light of each of the pixels.

5. The display method of claim 1, wherein the display method:
places a light source configured to generate both light in a visible spectrum and the light in the invisible spectrum behind the screen, blocks the light in the visible spectrum using an optical filter, and transmits only the light in the invisible spectrum; and
radiates the transmitted light in the invisible spectrum on the screen in which pixels arranged in a 2D array each include switching means for transmitting or blocking light, and forms the image by controlling the switching means and thereby an amount of transmission of the light in the invisible spectrum in each of the pixels.

6. The display method of claim 1, wherein:
the screen is configured such that pixels arranged in a 2D array each include a fluorescent material; and
the display method radiates an electron beam or light onto the fluorescent material of each of the pixels by adjusting energy generated behind the screen, and forms the image by adjusting an amount of generation of the light in the invisible spectrum in the pixel.

7. The display method of claim 1, wherein the display method:
further generates light in a visible spectrum, and further displays an image, formed by the light in the visible spectrum, on a screen; and
enables the images formed by the light in the visible spectrum and the light in the invisible spectrum to be watched.

8. The display method of claim 7, wherein:
the image displayed on the screen is a 3D image that is formed of a combination of a left-eye image formed by the light in the visible spectrum and a right-eye image formed by the light in the invisible spectrum; and
a user who wears a spectacle-type watching assistance means watches the left-eye image using a left-eye filter of the assistance means and watches the right-eye image using a right-eye filter of the assistance means.

9. The display method of claim 7, wherein:
the image formed by the light in the visible spectrum and the image formed by the light in the invisible spectrum are implemented on:
a physically single panel or film; or
physically different panels or films.

10. A display apparatus, comprising:
a light source configured to generate light in an invisible spectrum; and
a screen configured to display an image formed by the light in the invisible spectrum.

11. The display apparatus of claim 10, wherein the display apparatus enables the displayed image to be watched using means for enabling a user to view the light in the invisible spectrum.

12. The display apparatus of claim 10, wherein the light in the invisible spectrum is light in an infrared or ultraviolet spectrum.

13. The display apparatus of claim 10, wherein:
the screen is configured such that pixels arranged in a 2D array each include infrared or ultraviolet light generation means, and the image is generated by controlling the infrared or ultraviolet light generation means and thereby adjusting an amount of generation of infrared or ultraviolet light of each of the pixels.

14. The display apparatus of claim 10, further comprising an optical filter;
wherein the light source light in a visible spectrum in addition to the light in the invisible spectrum;
wherein the display apparatus:
places a light source configured to generate both light in a visible spectrum and the light in the invisible spectrum behind the screen location, blocks the light in the visible spectrum using an optical filter, and transmits only the light in the invisible spectrum; and
radiates the transmitted light in the invisible spectrum on the screen in which pixels arranged in a 2D array each include switching means for transmitting or blocking light, and forms the image by controlling the switching means and thereby an amount of transmission of the light in the invisible spectrum in each of the pixels.

15. The display apparatus of claim 10, further comprising an energy source;
wherein:
the screen is configured such that pixels arranged in a 2D array each include a fluorescent material;
the display method radiates an electron beam or light onto the fluorescent material of each of the pixels by adjusting the energy source behind the screen, and forms the image by adjusting an amount of generation of the light in the invisible spectrum in the pixel.

16. The display apparatus of claim 10, wherein:
the light source or another light source further generates light in a visible spectrum;
the screen further displays an image, formed by the light in the visible spectrum, on a screen; and
the display apparatus enables the images formed by the light in the visible spectrum and the light in the invisible spectrum to be watched.

17. The display apparatus of claim 16, wherein:
the image displayed on the screen is a 3D image that is formed of a combination of a left-eye image formed by the light in the visible spectrum and a right-eye image formed by the light in the invisible spectrum; and
a user who wears a spectacle-type watching assistance means watches the left-eye image using a left-eye filter of the assistance means and watches the right-eye image using a right-eye filter of the assistance means.

18. The display apparatus of claim 16, wherein:
the image formed by the light in the visible spectrum and the image formed by the light in the invisible spectrum are implemented on a physically single panel or film.

19. The display apparatus of claim 16, wherein the screen comprises:
a first panel or film configured to display the image formed by the light in the visible spectrum; and
a second panel or film configured to display the image formed by the light in the invisible spectrum.
